(19) United States
(12) Patent Application Publication
(10) Pub. No.: US 2017/0259199 A1
(43) Pub. Date: Sep. 14, 2017

(54) Filter Element

(71) Applicant: DACO S.R.O., Zilina (SK)

(72) Inventor: Dominik Jan H ARRAZOLA DE OÑATE, Budapest (HU)

(21) Appl. No.: 15/529,880

(22) PCT Filed: Nov. 26, 2015
(86) PCT No.: PCT/IB2015/002219

§ 371 Date: May 25, 2017

(30) Foreign Application Priority Data
Nov. 27, 2014 (BE) 2014/5088

(51) Int. Cl. B01D 46/02; B01D 46/52; B01D 46/00

(52) U.S. Cl. CPC B01D 46/023; B01D 46/002; B01D 46/0005; B01D 46/521

(57) ABSTRACT

A filter element for filtering impurities from air, comprises one or more filter packages whereby each filter package is made of a single-layered or multilayered filter medium and is connected to an inflow opening in an inlet piece. The inlet piece and the inflow opening of the inlet piece have an aerodynamic design, and that the filter package is essentially skittle-shaped, such that one end of which is open and fastened to the inflow opening and the other end of which is closed by a filter medium from which the filter package is also made.

The present invention relates to a filter element for filtering impurities from air.

More specifically the invention concerns a filter element that comprises one or more filter packages whereby each filter package is connected to an inlet piece, whereby this filter element is intended for removing dust, dirt and other pollutants in the solid phase in the air.

Conventionally a filter package consists of a porous, pleated material such that there are many zigzag pleats.

Due to these pleats a compact filter package can be created with a large area of filter material.

The term ‘multi-pleat’ or ‘mini-pleat’ is often used here.

Such conventional filter elements with a filter package are already known that are used for static filtration in air conditioning and ventilation. More specifically, also in the industry for filtration in oven ventilation and as an alternative for filter cartridges in the air inlet of gas turbines.

The conventional filter elements with a filter package are also applied in gas turbines, as absolute filters or HEPA filters.

This type of filter is suitable for removing small particles with dimensions of less than 0.3 or 0.1 microns from air, by the filter being provided with a filter package through which air can flow, but which is impermeable to the pollutants.

To this end the filter package is made of a suitable material depending on the application and the type of pollutants, for example. Use can also be made of a filter medium that contains active carbon or another adsorbing or absorbing material. In this case the filter can also act as a gas filter or as a combination of gas filtration and solid particle filtration.

It is known that the design of filter elements has not changed for a long time.

With such traditional filter elements the form is not optimum for realising a good flow of air.

A square or rectangular cross-section of the inlet opening of the filter package is often used, but this shape causes a large resistance to the air flow and a large pressure drop or large pressure loss in the air at the level of the element.

Likewise, the filter frame is not of a good design and contributes to the pressure loss.

This has the disadvantage that more energy is required to guide and filter the same volume of air through the filter element.

The shape of the filter package is not aerodynamic either, such that the air resistance over the entire surface of the filter is relatively high and is not constant either.

This will be detrimental to the efficient operation of the filter element, as the entire surface of the filter package is not utilised to the same extent.

As a result, dust, dirt and impurities can accumulate locally more quickly and the filter package can become saturated more quickly.

The purpose of the present invention is to provide a solution to at least one of the aforementioned and other disadvantages.

The object of the present invention is a filter element for filtering impurities from air, whereby the filter element comprises one or more filter packages whereby each filter package is made of a single-layered or multilayered filter medium and is connected to an inflow opening in an inlet piece, whereby the inlet piece and the inflow opening of the inlet piece have an aerodynamic design, and whereby the filter package is essentially skittle-shaped, one end of which is open and fastened to the inflow opening and the other end of which is closed by a filter medium from which the filter package is also made.

Skittle-shaped here means a form similar to a cone or ‘pin’ of a game of skittles or bowling.

‘Closed’ end here means that the end is not open, but that air can flow through it because it is closed by means of a filter material, for example.

An advantage is that due to the aerodynamic design the flow resistance of air through the filter element will be kept to a minimum.

Moreover, the pressure drop across the element will be kept to a minimum, which provides the advantage that less energy is needed to make air flow through the element.

This will have the result that a filter element according to the invention is a minimum of 25% more energy efficient than conventional filter elements.

The filter package comprises at least one layer of pleated filter material (mini-pleat or multi-pleat).

It is possible that there is more than one layer of filter material, whereby all layers are not necessarily made of pleated filter material (mini-pleat multi-pleat).

In the following, filter package means a single or multilayered filter package of which at least one layer is made of pleated filter material.

Preferably the diameter of the filter package changes in the longitudinal direction of the filter package, whereby the diameter remains constant or approximately constant from the inflow opening over a certain distance of the length of the filter package, after which the diameter then gradually decreases over a certain distance, after which the diameter again gradually increases and whereby the closed end is flat.

This has the advantage that such a filter package, in combination with the aerodynamic design of the inlet piece, will ensure that the air resistance is equal over the entire surface and as low as possible, such that the air flows through the entire surface of the filter package uniformly and evenly. Consequently the impurities will be evenly distributed over the surface of the filter package.

The invention also concerns a filter combination that consists of two or more filter elements according to the invention, of which the filter packages of these filter elements are inserted into one another to form a compact filter combination.

With the intention of better showing the characteristics of the invention, a few preferred embodiments of a filter element and a filter combination according to the invention are described hereinafter by way of an example, without any limiting nature, with reference to the accompanying drawings, wherein:

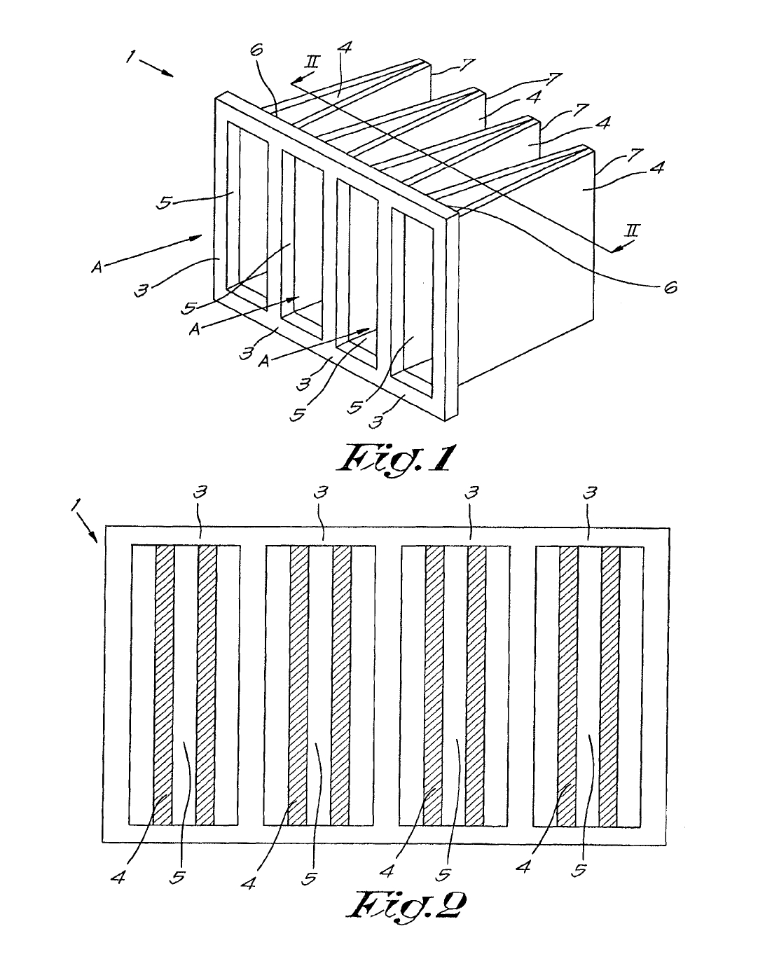

FIG. 1 schematically shows a perspective view of a conventional filter element;

FIG. 2 schematically shows a cross-section according to the line II-II in FIG. 1;

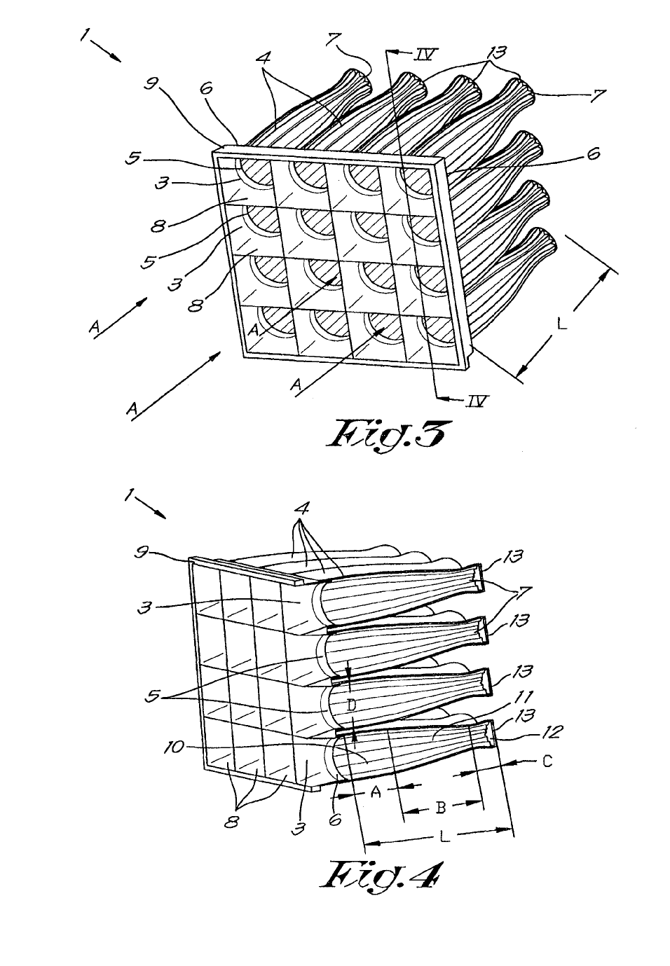

FIG. 3 schematically shows a perspective view of a filter element according to the invention;

FIG. 4 shows a cross-section according to the line IV-IV in FIG. 3;

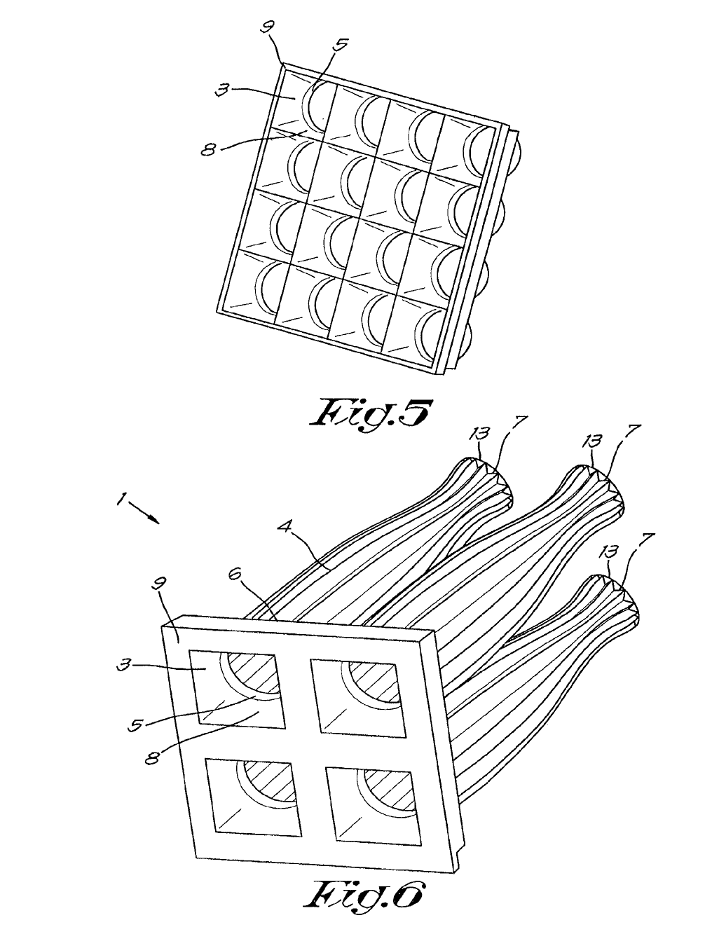

FIG. 5 schematically shows a perspective view of the frame of the filter element of FIG. 3;

FIG. 6 schematically shows a perspective view of an alternative embodiment of a filter element according to the invention;

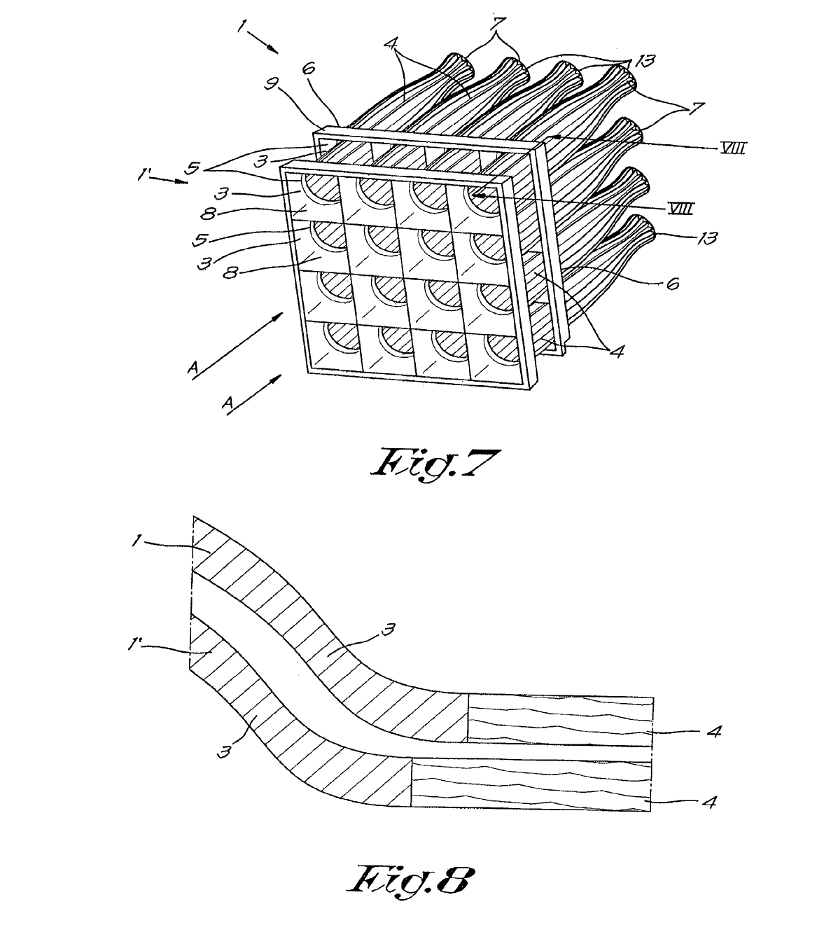

FIG. 7 schematically shows a perspective view of a filter combination according to the invention;

FIG. 8 schematically shows a cross-section according to the line VIII-VIII in FIG. 7.

The traditional filter element 1 shown in FIG. 1 essentially comprises a number of filter packages 4, in this case three, that are each provided with an inlet piece 3.

The inlet pieces 3 are placed next to one another and combined into a single unit.

Each inlet piece 3 has a rectangular or beam-shaped design and a rectangular inflow opening 5 for air.

The rectangular and tapering filter package 4 is affixed on each inlet piece 3, that has an open cross-section on one side 6 and is closed on the other side 7.

FIG. 2 shows a cross-section of a filter package 4. The filter package 4 is made of a filter medium that presents multiple zigzag pleats. Due to these zigzag pleats the area of the filter package 4 will be increased. The successive pleats are relatively close together.

Although in this case the filter package 4 only contains one layer of filter medium, it is not excluded that there are two, three or more layers of filter medium.

They do not all have to consist of multiple zigzag pleated filter medium.

The material of each layer of filter medium can be different, whereby for example each layer filters a different size or type of particles.

The cross-section of the filter package 4 is rectangular, i.e. the defined casing on the filter package 4 has a rectangular cross-section.

Such traditional filter elements 1 are used in air purification systems for example, where the air to be purified is guided through the filter element in the direction of the arrows A in order to filter dust, dirt or impurities from the air.

Due to the rectangular shape of the inlet pieces 3 and the form of the filter package 4, the air to be filtered that flows through the filter package 4 via the inflow opening 5 will experience a lot of resistance.

As a result more energy will be required to drive the air through the filter element 1.

Moreover, the combination of the design of the inlet piece 3 and the filter package 4 will ensure that the air resistance over the surface of the filter package 4 is not constant so that the impurities are not distributed evenly over the surface of the filter package 4, which leads to the filter element 1 not being used efficiently.

The filter element 1 according to the invention shown in FIGS. 3 and 4 comprises a number of filter packages 4, in this case 16, that are each connected to an inflow opening 5 in an inlet piece 3.

According to the invention the inlet piece 3 has an aerodynamic design, which means that the sidewalls 8 of the inlet piece 3 are curved at the location of the inflow openings 5 according to a well-defined curve or curvature.

This curve can be determined on the basis of simulations and calculations using a simulation program based on fluid mechanics, more specifically fluid dynamics.

On the basis of these calculations the design can be determined for which the air flow resistance is as low as possible.

In this case the inflow opening 5 has a circular cross-section. It is also possible that the inflow opening 5 has an oval or polygonal cross-section. For example, an octagonal or decagonal cross-section is also possible. In other words the shape of the inflow opening 5 is circular or one of its derived forms.

With the aforementioned calculations it can be determined which inflow opening 5 causes the least resistance to the flow of air, taking account of the flow rate or the medium from which the filter package is made.

As shown in FIG. 5, in this case the inlet pieces 3 are arranged in a 4×4 matrix, whereby the inlet pieces 3 are connected together for example by means of suitable fasteners not shown in the drawings, such as clips or similar, possibly in combination with seals, whereby the inlet pieces 3 are affixed in a frame 9 that fits around the matrix of inlet pieces 3.

It is possible that this frame 9 is left out.

Such a structure of the filter element 1 will enable a suitable number of filter packages 4 to be used in a suitable configuration according to the situation or application for which the filter element is to be used.

Moreover, in this case each inlet piece 3 can be separately detached from the frame 9 and the other inlet pieces 3.

As a result a complete filter package 4 with its inlet piece 3 can be replaced or detached if necessary.

The filter package 4 is affixed immediately after the inlet piece 3, as it were in line with the inflow opening 5.

The filter package 4 is essentially skittle-shaped and is fastened by its open end 6 to the inflow opening 5. The other end 7 of the filter package 4 is closed off by a filter package 4, as explained further in the text.

The cross-section of the filter package 4 in a plane parallel to the inflow opening 5 is circular in this case, just like the shape of the inflow opening 5. This cross-section can also be oval of polygonal. The cross-sections will have different dimensions at different locations along the longitudinal direction of the filter package 4, but they will all be identical in shape.

In this case the design of the filter package 4 is also determined on the basis of the aforementioned calculations, so that the air resistance over the entire surface of the filter package 4 is constant, so that the impurities are caught evenly over the surface of the filter package 4.

More specifically the diameter D of the filter package 4 changes in the longitudinal direction of the filter package. This means that the cross-section of the filter package 4 is not constant in the longitudinal direction.

In this case the filter package has the form of a skittle in a game of bowling.

The filter package 4 is divided into three parts 10, 11, 12, so to speak.

These three parts are indicated for one of the filter packages 4 in FIG. 4. The precise length of the different parts 10, 11, 12 will depend on the application and can be calculated using a simulation program based on fluid dynamics.

In this case the diameter D of the filter package 4 is constant in the first part 10.

In the second part 11 the diameter D gradually decreases, whereby in the third part 12 the diameter D increases again up to the end 7 of the filter package 4, where it is closed off by a filter package through which there is also a flow, in order to present the lowest possible air resistance.

In this case, the closed end 7 has a flat shape and in this case is formed by means of a cover 13. According to a preferred characteristic of the invention this cover 13 is made of a porous material, such as a suitable filter medium. The cover 13 is preferably made of the same filter medium as the rest of the filter package 4.

Preferably this cover 13 is formed by a filter package. A filter package ensures a better flow and thus less resistance.

Indeed, if the inflow is to occur with the lowest possible resistance, it is important that the air in the filter package 4 can flow to the outside with the least possible resistance. The provision of a cover of a filter material or filter package will ensure this.

The precise dimensions of the inlet piece 3 and the filter package 4 will depend on the flow rate of the air to be filtered, the impurities present or the material from which the filter package is made. However, the form of the filter package will always present a certain skittle shape or a form derived therefrom, whereby the diameter from the inflow opening is constant or approximately constant over a certain distance of the length of the filter package, after which the diameter then gradually decreases over a certain distance, after which the diameter gradually increases again and whereby the closed end has a spherical or practically spherical form.

In this case the filter package is made of a rigid material, for example pleated glass fibre paper, such that the shape of the filter package 4 is always preserved, even when no air is flowing through filter element.

As is known, the filter medium to be used is determined by the impurities to be removed, more specifically the filter medium must be impermeable to the impurities while the air must be able to flow through it. It is consequently not excluded that the filter medium from which the filter package 4 is made comprises at least one of the following materials: paper, plastic, metal gauze, woven fabric, non-woven fabric or another perforated material if the application so requires.

The operation of the filter element 1 of FIGS. 3 and 4 is very simple and as follows.

A filter element 1 according to the invention can be used to filter air in order to remove dust, dirt and other impurities in the solid phase from the air. If the filter package 4 contains active carbon, the filter element 1 will also be able to remove impurities in the gas phase from the air.

When the filter element 1 is in use, air will flow through it whereby the air will flow through the inlet pieces 3, via the inflow openings 5, to the filter packages 4, according to the arrows A.

Due to the aerodynamic design of the inlet pieces 3 and the filter packages 4, the flow resistance of the air through the filter element 1 will be minimal, such that less energy is required to drive the same quantity of air through the filter element 1.

The pressure drop across the filter element 1 will be lower compared to the conventional filter elements 1.

Moreover, the resistance of the air over the entire surface of the filter package 4 will be equal and minimal, such that air will flow through the entire surface evenly and impurities will be caught evenly.

Moreover, the cover 13 of filter medium will ensure that the air can also flow through the cover 13 itself to the outside, so that the resistance and pressure drop are minimal.

When the air flows through the filter packages 4, the impurities present in the air will be obstructed by the filter packages 4 as they are not permeable to the impurities.

The air that flows through the filter packages 4 will consequently be free of impurities.

When a certain quantity of dirt, dust and other impurities have accumulated in the filter packages 4, the good operation of the filter element 1 will be reduced because the filter packages 4 are partially filled with impurities.

By detaching the inlet pieces 3 from the filter element 1, the fouled filter packages 4 are taken from the filter element 1 and they can be cleaned and then fastened again in the filter element 1.

It is also possible but not necessary that use is made of disposable filter packages 4, whereby the fouled filter packages 4 are replaced by new filters.

Due to the aerodynamic design of the inlet pieces 3 and the filter packages 4, the entire surface of the filter package 4 is utilised, such that a local accumulation of impurities is not possible and thus there is no accompanying blockage or clogging of the filter package 4. Consequently the filter package 4 can be used for longer before it has to be replaced or cleaned.

It is possible that in the first part 10 the diameter D is not constant, but that the filter package 4 has a somewhat larger diameter D at a certain distance from the inflow opening 5. An example of such a form of filter package 4 is shown in FIG. 6.

FIG. 6 shows an alternative embodiment of a filter element 1 according to the invention.

Hereby, in this example a frame 9 is provided in which four inlet pieces 3 are affixed in this case. In this case the inlet pieces 3 together with a frame 9 form a single unit. This has the advantage that there is no possibility for air to be able to flow through the filter element 1 between two inlet pieces 3.

The unit can be made of plastic by injection moulding, for example.

It is clear that in this case the inlet pieces 3 are not detachable from one another or can be separated from the frame 9.

The design of the inlet pieces 3 is the same as in the previously described embodiment.

Each inlet piece 3 is provided with a filter package 4 that has a similar shape to the filter package 4 of the previous embodiment.

According to a particular characteristic of the invention each filter package 4 is separately detachable from the inlet piece 3 concerned.

This has the advantage that the filter element 1 can also be used in combination with disposable filter packages.

It is clear that it is also possible for the filter package 4 to form an inextricable unit with the inlet piece 3 concerned.

The operation of the filter element 1 of FIG. 6 is analogous to the embodiment described above.

In this case, when necessary, it will be possible to separately detach a filter package 4 from the inlet piece 3 and to replace it or clean it and then to fasten it back to the inlet piece 3 again.

It is clear that it is possible that the filter element 1 is provided with only one inlet piece 3 in which a number of inflow openings 5 are provided, whereby a filter package 4 is provided for each inflow opening 5.

It is clear that 16 or 4 filter packages 42 do not necessarily have to be present in the filter element 1.

On the basis of calculations it has turned out that 16 or 25 filter packages, for example arranged in a 4×4 or 5×5 matrix, guarantee an optimum air flow. Also a 3×3 or 4×5 matrix are within the scope of the invention. It is clear that the number of filter packages 4 as described is purely illustrative and that all possible combinations of numbers are possible without departing from the scope of the invention.

It is also not necessary for the filter packages 4 with their inlet piece 3 to be arranged in a square matrix or otherwise.

The invention also concerns a filter combination 14 that consists of two or more filter elements 1 according to the invention, of which the filter packages 4 of these filter elements 1 are inserted into one another to form a compact filter combination.

Such a filter combination 14 is also shown in FIGS. 7 and 8.

Hereby the external dimensions of the filter packages 4 of the first filter element 1, also called a prefilter element, are smaller than the internal dimensions of the filter packages 4 of the second filter element 1, so that the filter packages 4 can be inserted into one another.

For example, the filter elements 1 concern a prefilter element and a fine filter element or an active carbon filter element with a fine filter element.

Although in the example shown two filter elements 1 are placed in one another to form the filter combination 14, it is not excluded that more than two filter elements 1 are placed in one another.

An advantage of such a filter combination 14 is that it saves a lot of space and makes the construction of filter devices in which the filter combination 14 is applied cheaper and simpler.

The present invention is by no means limited to the embodiments described as an example and shown in the drawings, but a filter element and a filter combination according to the invention can be realised in all kinds of forms and dimensions, without departing from the scope of the invention.

1-12. (canceled)

13. A filter element for filtering impurities from air, whereby the filter element comprises one or more filter packages whereby each filter package is made of a single-layered or multilayered filter medium and is connected to an inflow opening in an inlet piece, wherein the inlet piece and the inflow opening of the inlet piece have an aerodynamic design, and that the filter package is essentially skittle-shaped, one end of which is open and fastened to the inflow opening and the other end of which is closed by a filter medium from which the filter package is also made.

14. The filter element according to claim 13, wherein the inflow opening of the inlet piece has a circular, polygonal or oval cross-section, whereby the cross-sections of the filter package parallel to the inflow opening are also circular, polygonal or oval.

15. The filter element according to claim 13, wherein the diameter of the filter package changes in the longitudinal direction of the filter package, whereby the diameter remains constant or approximately constant over a certain distance of the length of the filter package from the inflow opening, after which the diameter then gradually decreases over a certain distance, after which the diameter again gradually increases and whereby the closed end is flat.

16. The filter element according to claim 13, wherein the one or more filter packages are closed at the other end by a filter package and thus also filters the air and creates a better flow, and thus a lower pressure drop across the filter element.

17. The filter element according to claim 13, wherein the filter element comprises a number of filter packages that are connected together by their inlet piece.

18. The filter element according to claim 13, wherein the filter element comprises a number of filter packages that are affixed in a frame by their inlet piece.

19. The filter element according to claim 13, wherein the inlet pieces, and if applicable the frame, form a single unit.

20. The filter element according to claim 13, wherein each filter package can be separately detached from the inlet piece and can be replaced.

21. The filter element according to claim 13, wherein the inlet piece and the one or more filter packages form an inextricable unit.

22. The filter element according to claim 13, wherein the filter medium from which the filter package is made at least comprises one of the following materials: paper, glass fibre paper, plastic, metal gauze, woven fabric, non-woven fabric or another perforated material.

23. The filter element according to claim 13, wherein the filter package is made of a material that is rigid.

24. The filter combination, wherein the filter combination consists of two or more filter elements according to claim 13, of which the filter packages of the filter elements are inserted into one another to form a compact filter combination.
